(19) United States
(12) Patent Application Publication
(10) Pub. No.: US 2014/0045697 A1
(43) Pub. Date: Feb. 13, 2014

(54) ANDROSTANEDIOL DERIVATIVES AS PLANT GROWTH REGULATOR COMPOUNDS

(71) Applicants: Pierre Joseph Marcel Jung, Stein (CH); Anna Elizabeth Louw-Gaume, Stein (CH); Alain De Mesmaeker, Stein (CH); Mathilde Denise Lachia, Stein (CH)

(72) Inventors: Pierre Joseph Marcel Jung, Stein (CH); Anna Elizabeth Louw-Gaume, Stein (CH); Alain De Mesmaeker, Stein (CH); Mathilde Denise Lachia, Stein (CH)

(73) Assignee: SYNGENTA PARTICIPATIONS AG, Basel (CH)

(21) Appl. No.: 14/004,530

(22) PCT Filed: Mar. 8, 2012
(86) PCT No.: PCT/EP12/53983

§ 371 Date: Sep. 20, 2013

(30) Foreign Application Priority Data
Mar. 11, 2011 (GB) 1104199.3

(51) Int. Cl. A01N 45/00

(52) U.S. Cl. CPC A01N 45/00
USPC 504/348; 552/641; 552/615; 504/353

(57) ABSTRACT

The present invention relates to novel androstan derivatives, methods for their production, and their use for influencing plant growth.

The present invention relates to novel androstan derivatives, methods for their production, and their use for influencing plant growth.

Compounds derived from androstan and having plant growth properties are disclosed in WO03/00384 and WO2009/115060. There exists a need for alternative compounds for influencing plant growth. Preferably, new compounds may possess improved plant growth properties, such as improved efficacy, improved selectivity, reduced toxicity and lower tendency to generate soil persistence or environmental problem. Compounds may be more advantageously formulated or provide more efficient delivery and retention at sites of action, or may be more readily biodegradable.

It has surprisingly been found that certain androstan derivatives, which are substituted by a halogen or a carbonyl group at position 6, have beneficial properties, which makes them particularly suitable for use as a plant growth enhancer or regulator. In particular, such compounds unexpectedly provide better plant stem elongation properties, and greater systemicity than known derivatives such as 24-epi-brassinosteroid (24-epi) and close analogs such as described in WO2009/115060.

According to the present invention, there is provided a compound of formula (I)

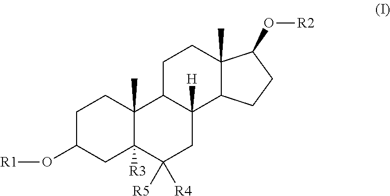

wherein
R1 and R2 are independently of one another H, C₁-C₈ alkyl, C₁-C₈ haloalkyl, C₁-C₈ alkyl-carbonyl, or C₁-C₈ alkoxycarbonyl;
R3 is hydrogen, C₁-C₄ alkoxy or halogen; and
R4 and R5 either i) are independently of one another hydrogen, hydroxyl or halogen, or ii) form a carbonyl or thio-carbonyl group except when R3 is fluorine.

The compounds of formula (I) may exist in different geometric or optical isomers (enantiomers and/or diasteroisomers) or tautomeric forms. The present invention includes all such isomers and tautomers of the compound of formula (I), and mixtures thereof in all proportions, as well as isotopic forms such as deuterated compounds. In a particular embodiment, when R3 is fluorine, R4 and R5 cannot be a carbonyl group.

Unless otherwise indicated, alkyl, on its own or as part of another group, such as alkoxy, alkylcarbonyl or alkoxycarbonyl, may be straight or branched chain and may preferably contain from 1 to 6 carbon atoms, more preferably 1 to 4, and most preferably 1 to 3. Examples of alkyl include methyl, ethyl, n-propyl, iso-propyl, n-butyl, sec-butyl, iso-butyl and tert-butyl.

Halogen means fluorine, chlorine, bromine or iodine.

Haloalkyl groups may contain one or more identical or different halogen atoms, and includes, for example, trifluoromethyl, chlorodifluoromethyl, 2,2,2-trifluoroethyl or 2,2-difluoroethyl. Perfluoroalkyl groups are alkyl groups which are completely substituted with fluorine atoms and include, for example, trifluoromethyl.

Preferred values of R1, R2, R3, R4 and R5 are, in any combination, as set out below.

Preferably R1 and R2 are independently of one another hydrogen, C₁-C₄ haloalkyl, C₁-C₄ alkylcarbonyl, C₁-C₄ alkoxycarbonyl. More preferably, R1 and R2 are independently of one another hydrogen, methyl or C₁-C₄ alkylcarbonyl. Preferably R1 and R2 are independently hydrogen or C₁ alkylcarbonyl. In one embodiment, R1 and R2 are hydrogen.

Preferably R3 is hydrogen, C₁-C₄ alkoxy or fluore. More preferably, R3 is hydrogen or C₁-C₄ alkoxy. Preferably, R3 is hydrogen or methoxy. In one embodiment, R3 is hydrogen. In another embodiment, R3 is C₁-C₄ alkoxy.

Preferably R4 and R5 are independently of one another hydrogen or halogen, or a carbonyl group formed from R4 and R5 except when R3 is fluorine. More preferably, R4 and R5 are independently of one another halogen, or a carbonyl group except when R3 is fluorine. In one embodiment, R4 and R5 are independently of each other hydrogen or halogen. In a further embodiment, R4 and R5 are independently of each other fluorine, chlorine, bromine or iodine. Preferably R4 and R5 are fluorine.

In one embodiment, R1 and R2 are each independently hydrogen, methyl, or C₁-C₄ alkylcarbonyl; R3 is hydrogen or methoxy; and R4 and R5 are each independently hydrogen or halogen.

Table 1 below includes examples of compounds of the present invention.

TABLE 1
(I)

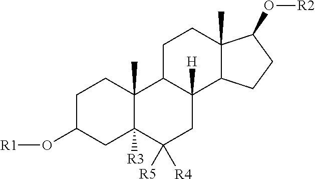

| Compound | R1 | R2 | R3 | R4 | R5 |
|---|---|---|---|---|---|
| 1.00 | C(O)Me | C(O)Me | F | F | F |
| 1.01 | H | H | F | F | F |
| 1.02 | H | H | H | F | F |
| 1.03 | C(O)Me | C(O)Me | H | F | F |
| 1.04 | H | H | OMe | C═O | |
| 1.05 | C(O)Me | C(O)Me | OMe | C═O | |
| 1.06 | C(O)Me | Me | F | F | F |
| 1.07 | H | Me | F | F | F |
| 1.08 | H | Me | H | F | F |
| 1.09 | C(O)Me | Me | H | F | F |
| 1.10 | H | Me | OMe | C═O | |
| 1.11 | C(O)Me | Me | OMe | C═O | |
| 1.12 | Me | C(O)Me | F | F | F |
| 1.13 | Me | H | F | F | F |
| 1.14 | Me | H | H | F | F |
| 1.15 | Me | C(O)Me | H | F | F |
| 1.16 | Me | H | OMe | C═O | |
| 1.17 | Me | C(O)Me | OMe | C═O | |
| 1.18 | C(O)Me | C(O)OMe | F | F | F |
| 1.19 | H | C(O)OMe | F | F | F |
| 1.20 | H | C(O)OMe | H | F | F |
| 1.21 | C(O)Me | C(O)OMe | H | F | F |
| 1.22 | H | C(O)OMe | OMe | C═O | |
| 1.23 | C(O)Me | C(O)OMe | OMe | C═O | |
| 1.24 | C(O)OMe | C(O)Me | F | F | F |
| 1.25 | C(O)OMe | H | F | F | F |
| 1.26 | C(O)OMe | H | H | F | F |
| 1.27 | C(O)OMe | C(O)Me | H | F | F |
| 1.28 | C(O)OMe | H | OMe | C═O | |
| 1.29 | C(O)OMe | C(O)Me | OMe | C═O | |
| 1.30 | C(O)Me | CF3 | F | F | F |
| 1.31 | H | CF3 | F | F | F |
| 1.32 | H | CF3 | H | F | F |
| 1.33 | C(O)Me | CF3 | H | F | F |
| 1.34 | H | CF3 | OMe | C═O | |
| 1.35 | C(O)Me | CF3 | OMe | C═O | |
| 1.36 | CF3 | C(O)Me | F | F | F |
| 1.37 | CF3 | H | F | F | F |
| 1.38 | CF3 | H | H | F | F |
| 1.39 | CF3 | C(O)Me | H | F | F |

| | | | | |
|---|---|---|---|---|
| 1.40 | CF3 | H | OMe | C═O |
| 1.41 | CF3 | C(O)Me | OMe | C═O |

Compounds of the present invention are particularly useful for enhancing the growth of crop plants. According to the present invention, there is provided a method for enhancing the growth of crop plants comprising applying to the plants, plant parts, plant propagation material or a plant growing locus a compound of formula I.

According to the present invention, “enhancing the growth of crops” means improving plant vigour, plant quality, tolerance to stress factors and/or input use efficiency.

According to the present invention, an ‘improvement in plant vigour’ means that certain traits are improved qualitatively or quantitatively when compared with the same trait in a control plant which has been grown under the same conditions in the absence of the method of the invention. Such traits include, but are not limited to, early and/or improved germination, improved emergence, the ability to use less seeds, increased root growth, a more developed root system, increased root nodulation, increased shoot growth, increased tillering, stronger tillers, more productive tillers, increased or improved plant stand, less plant verse (lodging), an increase and/or improvement in plant height, an increase in plant weight (fresh or dry), bigger leaf blades, greener leaf colour, increased pigment content, increased photosynthetic activity, earlier flowering, longer panicles, early grain maturity, increased seed, fruit or pod size, increased pod or ear number, increased seed number per pod or ear, increased seed mass, enhanced seed filling, less dead basal leaves, delay of senescence, improved vitality of the plant and/or less inputs needed (e.g. less fertiliser, water and/or labour needed). A plant with improved vigour may have an increase in any of the aforementioned traits or any combination or two or more of the aforementioned traits.

According to the present invention, an ‘improvement in plant quality’ means that certain traits are improved qualitatively or quantitatively when compared with the same trait in a control plant which has been grown under the same conditions in the absence of the method of the invention. Such traits include, but are not limited to, improved visual appearance of the plant, reduced ethylene (reduced production and/or inhibition of reception), improved quality of harvested material, e.g. seeds, fruits, leaves, vegetables (such improved quality may manifest as improved visual appearance of the harvested material, improved carbohydrate content (e.g. increased quantities of sugar and/or starch, improved sugar acid ratio, reduction of reducing sugars, increased rate of development of sugar), improved protein content, improved oil content and composition, improved nutritional value, reduction in anti-nutritional compounds, improved organoleptic properties (e.g. improved taste) and/or improved consumer health benefits (e.g. increased levels of vitamins and anti-oxidants)), improved post-harvest characteristics (e.g. enhanced shelf-life and/or storage stability, easier processability, easier extraction of compounds) more homogenous crop development (e.g. synchronised germination, flowering and/or fruiting of plants), and/or improved seed quality (e.g. for use in following seasons). A plant with improved quality may have an increase in any of the aforementioned traits or any combination or two or more of the aforementioned traits.

According to the present invention, an ‘improved tolerance to stress factors’ means that certain traits are improved qualitatively or quantitatively when compared with the same trait in a control plant which has been grown under the same conditions in the absence of the method of the invention. Such traits include, but are not limited to, an increased tolerance and/or resistance to abiotic stress factors which cause sub-optimal growing conditions such as drought (e.g. any stress which leads to a lack of water content in plants, a lack of water uptake potential or a reduction in the water supply to plants), cold exposure, heat exposure, osmotic stress, UV stress, flooding, increased salinity (e.g. in the soil), increased mineral exposure, ozone exposure, high light exposure and/or limited availability of nutrients (e.g. nitrogen and/or phosphorus nutrients). A plant with improved tolerance to stress factors may have an increase in any of the aforementioned traits or any combination or two or more of the aforementioned traits. In the case of drought and nutrient stress, such improved tolerances may be due to, for example, more efficient uptake, use or retention of water and nutrients.

According to the present invention, an ‘improved input use efficiency’ means that the plants are able to grow more effectively using given levels of inputs compared to the grown of control plants which are grown under the same conditions in the absence of the method of the invention. In particular, the inputs include, but are not limited to fertiliser (such as nitrogen, phosphorous, potassium, micronutrients), light and water. A plant with improved input use efficiency may have an improved use of any of the aforementioned inputs or any combination of two or more of the aforementioned inputs.

Other crop enhancements of the present invention include a decrease in plant height, or reduction in tillering, which are beneficial features in crops or conditions where it is desirable to have less biomass and fewer tillers.

Any or all of the above crop enhancements may lead to an improved yield by improving e.g. plant physiology, plant growth and development and/or plant architecture. In the context of the present invention ‘yield’ includes, but is not limited to, (i) an increase in biomass production, grain yield, starch content, oil content and/or protein content, which may result from (a) an increase in the amount produced by the plant per se or (b) an improved ability to harvest plant matter, (ii) an improvement in the composition of the harvested material (e.g. improved sugar acid ratios, improved oil composition, increased nutritional value, reduction of anti-nutritional compounds, increased consumer health benefits) and/or (iii) an increased/facilitated ability to harvest the crop, improved processability of the crop and/or better storage stability/shelf life. Increased yield of an agricultural plant means that, where it is possible to take a quantitative measurement, the yield of a product of the respective plant is increased by a measurable amount over the yield of the same product of the plant produced under the same conditions, but without application of the present invention. According to the present invention, it is preferred that the yield be increased by at least 0.5%, more preferred at least 1%, even more preferred at least 2%, still more preferred at least 4%, preferably 5% or even more.

Any or all of the above crop enhancements may also lead to an improved utilisation of land, i.e. land which was previously unavailable or sub-optimal for cultivation may become available. For example, plants which show an increased ability to survive in drought conditions, may be able to be cultivated in areas of sub-optimal rainfall, e.g. perhaps on the fringe of a desert or even the desert itself.

The compounds of Formula I according to the invention can be used as plant growth regulators by themselves, but are generally formulated into plant growth enhancement or regulation compositions using formulation adjuvants, such as carriers, solvents and surface-active agents (SFAs). Thus, the present invention further provides a plant growth enhancer or regulator composition comprising a compound of formula (I) as defined above and an agriculturally acceptable formulation adjuvant. The composition may be in the form of a concentrate which is diluted prior to use, or a ready-to-use composition. The final dilution is usually made with water, but can be made instead of, or in addition to, water, with, for example, liquid fertilisers, micronutrients, biological organisms, oil or solvents.

The compositions generally comprise from 0.0001% to 99% by weight, especially from 0.0001% to 95% by weight, compounds of Formula I and from 1 to 99.9% by weight of a formulation adjuvant which preferably includes from 0 to 25% by weight of a surface-active substance.

The compositions can be chosen from a number of formulation types, many of which are known from the Manual on Development and Use of FAO Specifications for Plant Protection Products, 5th Edition, 1999. These include dustable powders (DP), soluble powders (SP), water soluble granules (SG), water dispersible granules (WG), wettable powders (WP), granules (GR) (slow or fast release), soluble concentrates (SL), oil miscible liquids (OL), ultra low volume liquids (UL), emulsifiable concentrates (EC), dispersible concentrates (DC), emulsions (both oil in water (EW) and water in oil (EO)), micro-emulsions (ME), suspension concentrates (SC), aerosols, capsule suspensions (CS) and seed treatment formulations. The formulation type chosen in any instance will depend upon the particular purpose envisaged and the physical, chemical and biological properties of the compound of Formula (I).

Dustable powders (DP) may be prepared by mixing a compound of Formula (I) with one or more solid diluents (for example natural clays, kaolin, pyrophyllite, bentonite, alumina, montmorillonite, kieselguhr, chalk, diatomaceous earths, calcium phosphates, calcium and magnesium carbonates, sulphur, lime, flours, talc and other organic and inorganic solid carriers) and mechanically grinding the mixture to a fine powder.

Soluble powders (SP) may be prepared by mixing a compound of Formula (I) with one or more water-soluble inorganic salts (such as sodium bicarbonate, sodium carbonate or magnesium sulphate) or one or more water-soluble organic solids (such as a polysaccharide) and, optionally, one or more wetting agents, one or more dispersing agents or a mixture of said agents to improve water dispersibility/solubility. The mixture is then ground to a fine powder. Similar compositions may also be granulated to form water soluble granules (SG).

Wettable powders (WP) may be prepared by mixing a compound of Formula (I) with one or more solid diluents or carriers, one or more wetting agents and, preferably, one or more dispersing agents and, optionally, one or more suspending agents to facilitate the dispersion in liquids. The mixture is then ground to a fine powder. Similar compositions may also be granulated to form water dispersible granules (WG).

Granules (GR) may be formed either by granulating a mixture of a compound of Formula (I) and one or more powdered solid diluents or carriers, or from pre-formed blank granules by absorbing a compound of Formula (I) (or a solution thereof, in a suitable agent) in a porous granular material (such as pumice, attapulgite clays, fuller's earth, kieselguhr, diatomaceous earths or ground corn cobs) or by adsorbing a compound of Formula (I) (or a solution thereof, in a suitable agent) on to a hard core material (such as sands, silicates, mineral carbonates, sulphates or phosphates) and drying if necessary. Agents which are commonly used to aid absorption or adsorption include solvents (such as aliphatic and aromatic petroleum solvents, alcohols, ethers, ketones and esters) and sticking agents (such as polyvinyl acetates, polyvinyl alcohols, dextrins, sugars and vegetable oils). One or more other additives may also be included in granules (for example an emulsifying agent, wetting agent or dispersing agent).

Dispersible Concentrates (DC) may be prepared by dissolving a compound of Formula (I) in water or an organic solvent, such as a ketone, alcohol or glycol ether. These solutions may contain a surface active agent (for example to improve water dilution or prevent crystallisation in a spray tank).

Emulsifiable concentrates (EC) or oil-in-water emulsions (EW) may be prepared by dissolving a compound of Formula (I) in an organic solvent (optionally containing one or more wetting agents, one or more emulsifying agents or a mixture of said agents). Suitable organic solvents for use in ECs include aromatic hydrocarbons (such as alkylbenzenes or alkylnaphthalenes, exemplified by SOLVESSO® 100, SOLVESSO® 150 and SOLVESSO® 200), ketones (such as cyclohexanone or methylcyclohexanone) and alcohols (such as benzyl alcohol, furfuryl alcohol or butanol), N-alkylpyrrolidones (such as N-methylpyrrolidone or N-octylpyrrolidone), dimethyl amides of fatty acids (such as C₈-C₁₀ fatty acid dimethylamide) and chlorinated hydrocarbons. An EC product may spontaneously emulsify on addition to water, to produce an emulsion with sufficient stability to allow spray application through appropriate equipment.

Preparation of an EW involves obtaining a compound of Formula (I) either as a liquid (if it is not a liquid at room temperature, it may be melted at a reasonable temperature, typically below 70° C.) or in solution (by dissolving it in an appropriate solvent) and then emulsifying the resultant liquid or solution into water containing one or more SFAs, under high shear, to produce an emulsion. Suitable solvents for use in EWs include vegetable oils, chlorinated hydrocarbons (such as chlorobenzenes), aromatic solvents (such as alkylbenzenes or alkylnaphthalenes) and other appropriate organic solvents which have a low solubility in water.

Microemulsions (ME) may be prepared by mixing water with a blend of one or more solvents with one or more SFAs, to produce spontaneously a thermodynamically stable isotropic liquid formulation. A compound of Formula (I) is present initially in either the water or the solvent/SFA blend. Suitable solvents for use in MEs include those hereinbefore described for use in ECs or in EWs. An ME may be either an oil-in-water or a water-in-oil system (which system is present may be determined by conductivity measurements) and may be suitable for mixing water-soluble and oil-soluble pesticides in the same formulation. An ME is suitable for dilution into water, either remaining as a microemulsion or forming a conventional oil-in-water emulsion.

Suspension concentrates (SC) may comprise aqueous or non-aqueous suspensions of finely divided insoluble solid particles of a compound of Formula (I). SCs may be prepared by ball or bead milling the solid compound of Formula (I) in a suitable medium, optionally with one or more dispersing agents, to produce a fine particle suspension of the compound. One or more wetting agents may be included in the composition and a suspending agent may be included to reduce the rate at which the particles settle. Alternatively, a compound of Formula (I) may be dry milled and added to water, containing agents hereinbefore described, to produce the desired end product.

Aerosol formulations comprise a compound of Formula (I) and a suitable propellant (for example n-butane). A compound of Formula (I) may also be dissolved or dispersed in a suitable medium (for example water or a water miscible liquid, such as n-propanol) to provide compositions for use in non-pressurised, hand-actuated spray pumps.

Capsule suspensions (CS) may be prepared in a manner similar to the preparation of EW formulations but with an additional polymerisation stage such that an aqueous dispersion of oil droplets is obtained, in which each oil droplet is encapsulated by a polymeric shell and contains a compound of Formula (I) and, optionally, a carrier or diluent therefor. The polymeric shell may be produced by either an interfacial polycondensation reaction or by a coacervation procedure. The compositions may provide for controlled release of the compound of Formula (I) and they may be used for seed treatment. A compound of Formula (I) may also be formulated in a biodegradable polymeric matrix to provide a slow, controlled release of the compound.

The composition may include one or more additives to improve the biological performance of the composition, for example by improving wetting, retention or distribution on surfaces; resistance to rain on treated surfaces; or uptake or mobility of a compound of Formula (I). Such additives include surface active agents (SFAs), spray additives based on oils, for example certain mineral oils or natural plant oils (such as soy bean and rape seed oil), and blends of these with other bio-enhancing adjuvants (ingredients which may aid or modify the action of a compound of Formula (I)).

Wetting agents, dispersing agents and emulsifying agents may be SFAs of the cationic, anionic, amphoteric or non-ionic type.

Suitable SFAs of the cationic type include quaternary ammonium compounds (for example cetyltrimethyl ammonium bromide), imidazolines and amine salts.

Suitable anionic SFAs include alkali metals salts of fatty acids, salts of aliphatic monoesters of sulphuric acid (for example sodium lauryl sulphate), salts of sulphonated aromatic compounds (for example sodium dodecylbenzenesulphonate, calcium dodecylbenzenesulphonate, butylnaphthalene sulphonate and mixtures of sodium di-isopropyl- and tri-isopropyl-naphthalene sulphonates), ether sulphates, alcohol ether sulphates (for example sodium laureth-3-sulphate), ether carboxylates (for example sodium laureth-3-carboxylate), phosphate esters (products from the reaction between one or more fatty alcohols and phosphoric acid (predominately mono-esters) or phosphorus pentoxide (predominately di-esters), for example the reaction between lauryl alcohol and tetraphosphoric acid; additionally these products may be ethoxylated), sulphosuccinamates, paraffin or olefine sulphonates, taurates and lignosulphonates.

Suitable SFAs of the amphoteric type include betaines, propionates and glycinates.

Suitable SFAs of the non-ionic type include condensation products of alkylene oxides, such as ethylene oxide, propylene oxide, butylene oxide or mixtures thereof, with fatty alcohols (such as oleyl alcohol or cetyl alcohol) or with alkylphenols (such as octylphenol, nonylphenol or octylcresol); partial esters derived from long chain fatty acids or hexitol anhydrides; condensation products of said partial esters with ethylene oxide; block polymers (comprising ethylene oxide and propylene oxide); alkanolamides; simple esters (for example fatty acid polyethylene glycol esters); amine oxides (for example lauryl dimethyl amine oxide); and lecithins.

Suitable suspending agents include hydrophilic colloids (such as polysaccharides, polyvinylpyrrolidone or sodium carboxymethylcellulose) and swelling clays (such as bentonite or attapulgite).

The present invention still further provides a method for enhancing or regulating the growth of plants in a locus comprising applying to the plants, plant parts, plant propagation material or the locus, an effective amount of a composition according to the present invention. An effective amount is one which is sufficient to result in plant growth enhancement or regulation. There is also provided the use of a compound or composition of the present invention for enhancing the growth of plants. In one embodiment, the compound or composition of the present invention improves plant growth. In a further embodiment, it improves plant resistance to abiotic stress factors. In a further embodiment, it improves yield.

The application is generally made by spraying the composition, typically by tractor mounted sprayer for large areas, but other methods such as dusting (for powders), drip or drench can also be used. Alternatively the composition may be applied in furrow or directly to a seed before or at the time of planting.

The compound of formula (I) or composition of the present invention may be applied to a plant, part of the plant, plant organ, plant propagation material or a surrounding area thereof.

In one embodiment, the invention relates to a method of enhancing the growth of plants comprising treating plant propagation material with a composition of the present invention, and planting the plant propagation material.

In one embodiment, the invention relates to a method of treating a plant propagation material comprising applying to the plant propagation material a composition of the present invention in an amount effective to regulate plant growth. The invention also relates to plant propagation material treated with a compound of formula (I) or a composition of the present invention. Preferably, the plant propagation material is a seed.

The term “plant propagation material” denotes all the generative parts of the plant, such as seeds, which can be used for the multiplication of the latter and vegetative plant materials such as cuttings and tubers. In particular, there may be mentioned the seeds, roots, fruits, tubers, bulbs, and rhizomes.

Methods for applying active ingredients to plant propagation material, especially seeds, are known in the art, and include dressing, coating, pelleting and soaking application methods of the propagation material. The treatment can be applied to the seed at any time between harvest of the seed and sowing of the seed or during the sowing process. The seed may also be primed either before or after the treatment. The compound of formula (I) may optionally be applied in combination with a controlled release coating or technology so that the compound is released over time.

The composition of the present invention may be applied pre-emergence or post-emergence. Suitably, where the composition is being used to regulate the growth of crop plants, it may be applied post-emergence of the crop; where the composition is used to promote the germination of seeds, it may be applied pre-emergence.

The rates of application of compounds of Formula I may vary within wide limits and depend on the nature of the soil, the method of application (pre- or post-emergence; seed dressing; application to the seed furrow; no tillage application etc.), the crop plant, the prevailing climatic conditions, and other factors governed by the method of application, the time of application and the target crop.

For foliar or drench application, the compounds of Formula I according to the invention are generally applied at a rate of from 0.0010 to 200 g/ha, especially from 0.010 to 100 g/ha. For seed treatment the rate of application is generally between 0.0005 and 150 g per 100 kg of seed.

Plants on which the composition according to the invention can be used include crops such as cereals (for example wheat, barley, rye, oats); beet (for example sugar beet or fodder beet); fruits (for example pomes, stone fruits or soft fruits, such as apples, pears, plums, peaches, almonds, cherries, strawberries, raspberries or blackberries); leguminous plants (for example beans, lentils, peas or soybeans); oil plants (for example rape, mustard, poppy, olives, sunflowers, coconut, castor oil plants, cocoa beans or groundnuts); cucumber plants (for example marrows, cucumbers or melons); fibre plants (for example cotton, flax, hemp or jute); citrus fruit (for example oranges, lemons, grapefruit or mandarins); vegetables (for example spinach, lettuce, asparagus, cabbages, carrots, onions, tomatoes, potatoes, cucurbits or paprika); lauraceae (for example avocados, cinnamon or camphor); maize; rice; tobacco; nuts; coffee; sugar cane; tea; vines; hops; durian; bananas; natural rubber plants; turf or ornamentals (for example flowers, shrubs, broad-leaved trees or evergreens such as conifers). This list does not represent any limitation.

The invention may also be used to regulate the growth of non-crop plants, for example to facilitate weed control by synchronizing germination.

Crops are to be understood as also including those crops which have been modified by conventional methods of breeding or by genetic engineering. For example, the invention may be used in conjunction with crops that have been rendered tolerant to herbicides or classes of herbicides (e.g. ALS-, GS-, EPSPS-, PPO-, ACCase- and HPPD-inhibitors). An example of a crop that has been rendered tolerant to imidazolinones, e.g. imazamox, by conventional methods of breeding is Clearfield® summer rape (canola). Examples of crops that have been rendered tolerant to herbicides by genetic engineering methods include e.g. glyphosate- and glufosinate-resistant maize varieties commercially available under the trade names RoundupReady® and LibertyLink®. Methods of rending crop plants tolerant to HPPD-inhibitors are known, for example from WO0246387; for example the crop plant is transgenic in respect of a polynucleotide comprising a DNA sequence which encodes an HPPD-inhibitor resistant HPPD enzyme derived from a bacterium, more particularly from Pseudomonas fluorescens or Shewanella colwelhana, or from a plant, more particularly, derived from a monocot plant or, yet more particularly, from a barley, maize, wheat, rice, Brachiaria, Chenchrus, Lolium, Festuca, Setaria, Eleusine, Sorghum or Avena species.

Crops are also to be understood as being those which have been rendered resistant to harmful insects by genetic engineering methods, for example Bt maize (resistant to European corn borer), Bt cotton (resistant to cotton boll weevil) and also Bt potatoes (resistant to Colorado beetle). Examples of Bt maize are the Bt 176 maize hybrids of NK® (Syngenta Seeds). The Bt toxin is a protein that is formed naturally by Bacillus thuringiensis soil bacteria. Examples of toxins, or transgenic plants able to synthesise such toxins, are described in EP-A-451 878, EP-A-374 753, WO 93/07278, WO 95/34656, WO 03/052073 and EP-A-427 529. Examples of transgenic plants comprising one or more genes that code for an insecticidal resistance and express one or more toxins are KnockOut® (maize), Yield Gard® (maize), NuCOTIN33B® (cotton), Bollgard® (cotton), NewLeaf® (potatoes), NatureGard® and Protexcta®. Plant crops or seed material thereof can be both resistant to herbicides and, at the same time, resistant to insect feeding (“stacked” transgenic events). For example, seed can have the ability to express an insecticidal Cry3 protein while at the same time being tolerant to glyphosate.

Crops are also to be understood to include those which are obtained by conventional methods of breeding or genetic engineering and contain so-called output traits (e.g. improved storage stability, higher nutritional value and improved flavour).

The compounds of the invention may be made by a variety of methods.

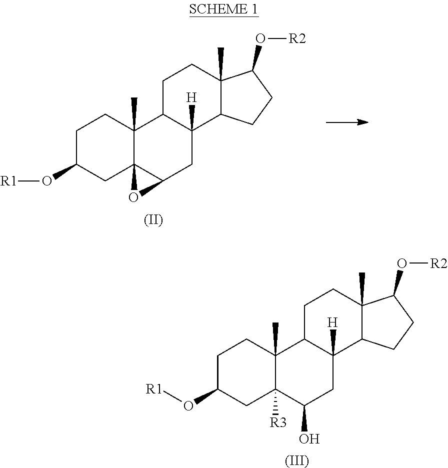

Starting compounds of formula (II) may be made by methods known to a person skilled in the art. For example, see Journal of Chemical Research, Synopses (2002), 11, 576-578; Journal of Chemical Research, Synopses (1998), (1), 50-51 Compounds of formula (III) may be made by treatment of compounds of formula (II) by reaction with the appropriate nucleophile, for example:
a) Compounds of formula (III), wherein R3 is C₁-C₄ alkoxy may be made by treatment of compounds of formula (II) with an alcohol such as methanol in presence of an acid such as p-toluenesulfonic acid, or a catalyst such hydrazine sulphate;
b) Compounds of formula (III), wherein R3 is H may be made by treatment of compounds of formula (II) with a reducing agent such as sodium cyanoborohydride, optionally in the presence of a catalyst such as boron trifluoride-diethyl etherate; or
c) Compounds of formula (III), wherein R3 is F may be made by treatment of compounds of formula (II) with a fluorinating agent such as boron fluoride diethyl etherate in a suitable solvent, such as diethyl ether.

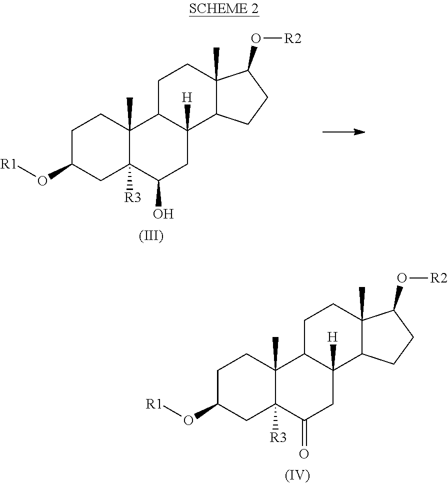

Compounds of formula (IV) may be made by treatment of compounds of formula (III) by reaction with an oxidizing agent such as pyridium chlorochromate in organic solvent such as dichloromethane, optionally in presence of water, a base or a salt, such as pyridium trifluoroacetate.

Oxidation reactions of androstan derivatives in position 6 may be made by methods known to the person skilled in the art (see for example: WO2007/147713; Journal of Medicinal Chemistry (2008), 51(13), 3979-3984; Steroids (2004), 69(10), 605-612; and Journal of Medicinal Chemistry (2003), 46(17), 3644-3654).

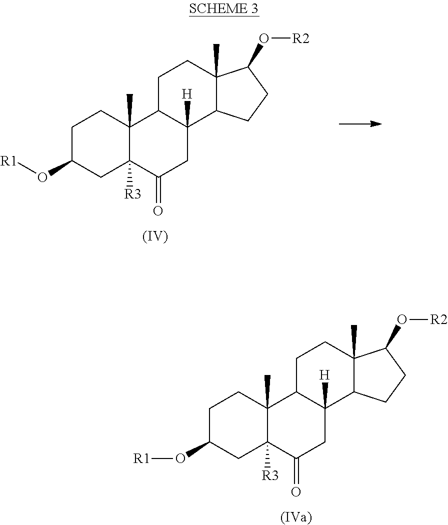

Compounds of formula (IVa), wherein R1 is H may be made by treatment of compounds of formula (IV), wherein R1 is C₁-C₄ alkylcarbonyl by hydrolysis in presence of a base, such as potassium carbonate, in alcohol or aqueous alcohol such as methanol.

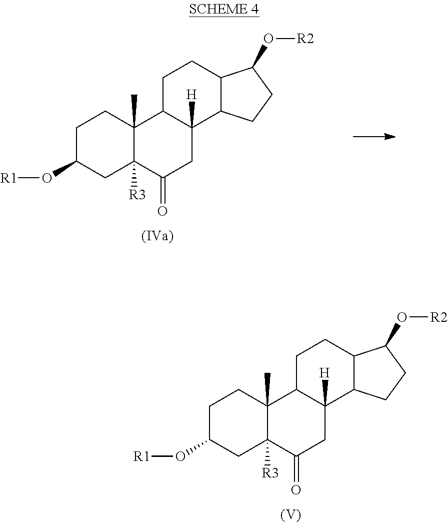

Compounds of formula (V) may be made by treatment of compounds of formula (IVa), wherein R1 is H by using the Mitsunobu reaction with a dialkylazodicarboxylate (such as diethyl azocarboxylate (DEAD)) and a trialkyl or triaryl phosphine (such as triphenylphosphine) in suitable solvent (such as tetrhydrofurane) in presence of an acid such as acetic acid.

Alternatively, compounds of formula (V) may be made by treatment of compounds of formula (IVa), wherein R1 is H by a) the formation of a leaving group such as tosylate or mesylate, b) displacement of this leaving group by sodium nitrite in a suitable solvent such as HMPA and c) followed by hydrolysis (see for example: Journal of Medicinal Chemistry (2008), 51(13), p. 39′79-3984)

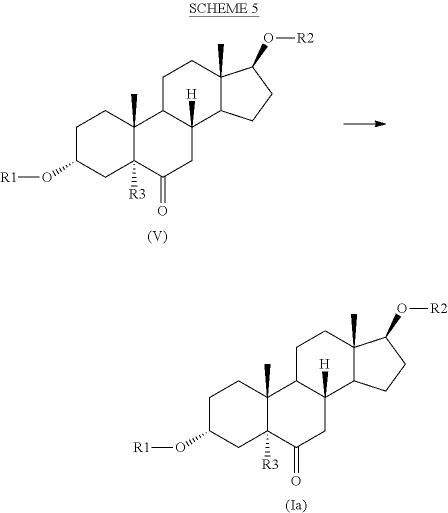

Compounds of formula (Ia), wherein R1 and/or R2 are H, may be made by treatment of compounds of formula (V), wherein R1 and/or R2 are C₁-C₄ alkylcarbonyl by hydrolysis in alkaline medium (such as alkali carbonate), hydroxide (such as sodium hydroxyl) or potassium carbonate, or in acidic medium (such as hydrochloric), in suitable a solvent (such as methanol).

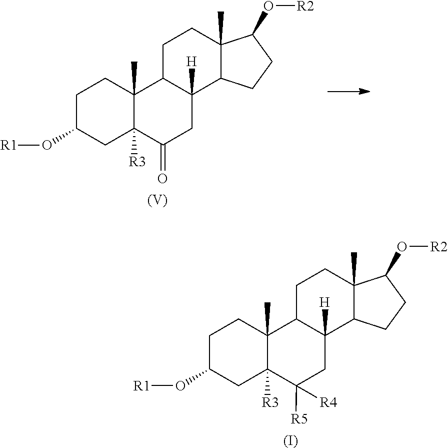

Alternatively, compounds of formula (I), may be made by treatment of compounds of formula (V) with a fluorinating agent such as DAST, sulfur tetrafluoride or deoxofluor, in suitable solvent such as dichloromethane.

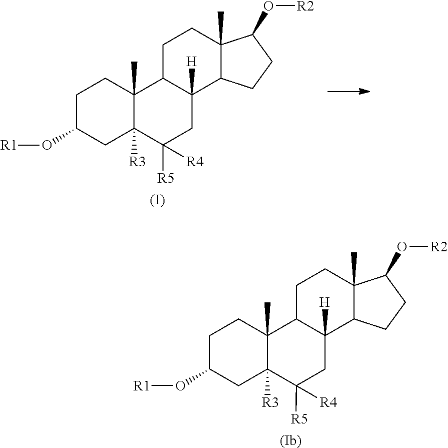

Compounds of formula (Ib), wherein R1 and/or R2 are H, may be made by treatment of compounds of formula (I), wherein R1 and/or R2 are C₁-C₄ alkylcarbonyl via hydrolysis in alkaline medium (such as alkali carbonate), hydroxide (such as sodium hydroxyl), or potassium carbonate, or in acidic medium (such as hydrochloric), in suitable solvent (such as methanol).

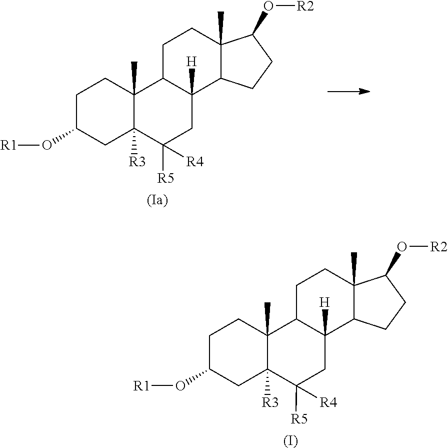

Compounds of formula (I) may be made by treatment of compounds of formula (Ia), wherein R1 is H with an alkylating such as alkyl iodine or acylating agent, such as acid chloride, optionally in presence of an organic or mineral base, in a suitable solvent.

### EXAMPLES

### Example P1

### Synthesis of 5-Fluoro-6α,6β-difluoro-3α,17β-dihydroxy-5α-androstan (compound 1.01)

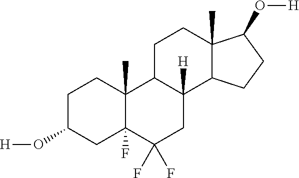

### Step 1: Synthesis of 5-Fluoro- -3α,17β-di acetyloxy-5α-androstan 6-one

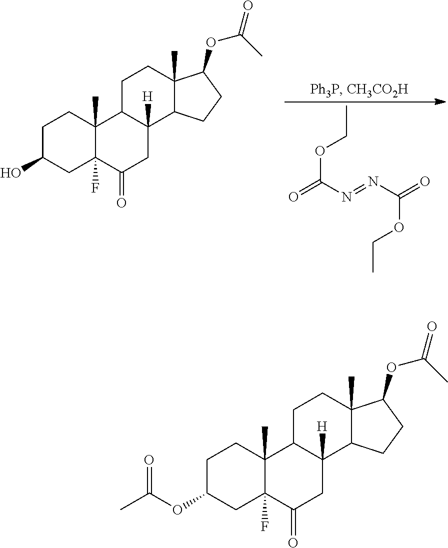

To a solution of 5-fluoro-3β-hydroxy-6-oxo-5α-androstan-17β-yl acetate (Prepared as described in WO2009115060 and Journal of Medicinal Chemistry (2008), 51(13), p 3979) (2.89 g, 7.90 mmol) in anhydrous THF (80 mL) containing triphenylphosphine (4.14 g, 15.80 mmol) and acetic acid (0.90 mL, 15.80 mmol) was added a solution of diethylazodicarboxylate (2.75 g, 15.80 mmol) in anhydrous tetrahydrofurane (20 mL). The reaction mixture was stirred for 14 h at 60° C. overnight and evaporated to dryness after addition of silica gel. The residue was purified by column chromatography on silica gel (eluent: ethyl acetate/hexane) to give 5-Fluoro- -3α,17β-di acetyloxy-5α-androstan 6-one (1.5 g, 47%). Mp° C.: 168-170° C. ¹H NMR (selected protons, CDCl₃, 400 MHz): 5.11 (sb, 1H), 4.63 (t, 1H), 2.05 (s, 3H, C(O)CH₃), 2.03 (s, 3H, C(O)CH₃), 0.76 (s, 3H, CH₃), 0.78 (s, 3H, CH₃) ppm.

### Step 2: Synthesis of 5-Fluoro-6α,6β-difluoro-3α,17β-di acetyloxy-5α-androstan

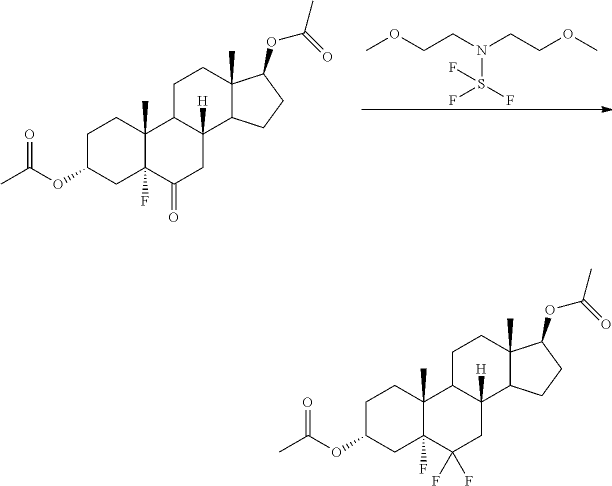

Deoxofluor (5.16 mL, 14 mmol, 50% solution) was added slowly over 5 min to a 0° C. solution of 5-Fluoro- -3α,17β-di acetyloxy-5α-androstan 6-one (0.204 g, 0.50 mmol) in dichloromethane (5 mL). After 20 h at 60° C., 2 ml of deoxofluor were added and the reaction was stirred 20 hours more at 60° C. The reaction was quenched by the careful addition of an equal volume of ice-water. After separation of the phases, the aqueous layer was extracted with dichloromethane (3×) and the combined organics were dried over sodium sulfate and concentrated under vacuum with 8 mL of SiOH 60. Purification: Büchi Sepacore, cartridge 12×150, eluted with a gradient of ethylacetate in cyclohexane 1 to 30% over a 2 hrs. period, flow 15 ml/min to give 180 mg of 5-Fluoro-6α,6β-difluoro-3α,17β-di acetyloxy-5α-androstan (84% yield). ¹H NMR (selected protons, CDCl₃, 400 MHz): 5.17 (sb, 1H), 4.63 (t, 1H), 2.03 (s, 6H, 2×C(O)CH₃), 1.02 (d, 3H, CH₃), 0.81 (s, 3H, CH₃) ppm.

### Step 3: Synthesis of 5-Fluoro-6α,6β-difluoro-3α,17β-dihydroxyl-5α-androstan

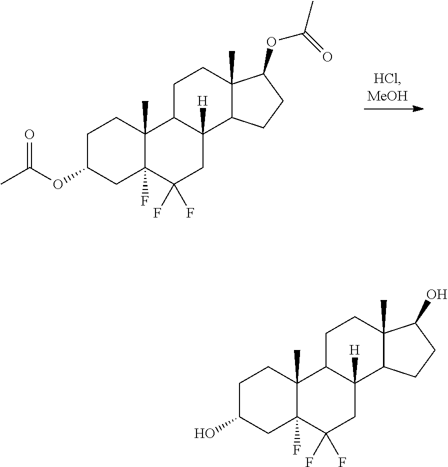

A solution of hydrochloric acid (1.0 mL) in methanol (10 mL) was added to a solution of 5-Fluoro-6α,6β-difluoro-3α,17β-di acetyloxy-5α-androstan (0.172 g, 0.40 mmol) in chloroform (2 mL) and the reaction mixture was allowed to stand at room temperature for 20 hours. A saturated solution of potassium carbonate was added and the product was extracted with dichloromethane (3×). The combined organic extracts were dried over sodium sulfate and the solvent evaporated. The residue was purified by cristallisation in aqueous ethanol to give the 5-Fluoro-6α,6β-difluoro-3α,17β-di hydroxyl-5α-androstan (0.097 g, 70%). Mp° C.: 194-198° C.). ¹H NMR (selected protons, CDCl₃, 400 MHz): 4.12 (db, 1H), 3.68 (m, 1H), 1.03 (d, 3H, CH₃), 0.76 (s, 3H, CH₃) ppm.

### Example P2

### Synthesis of 5-Fluoro-6α,6β-difluoro-3α,17β-dihydroxy-5α-androstan (compound 1.02)

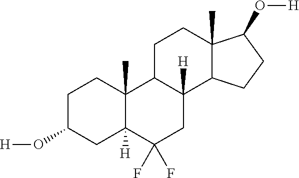

### Step 1: Synthesis of 5.α-Androstane-3.β.,6.β.,17.β.-triol, 3,17-diacetate

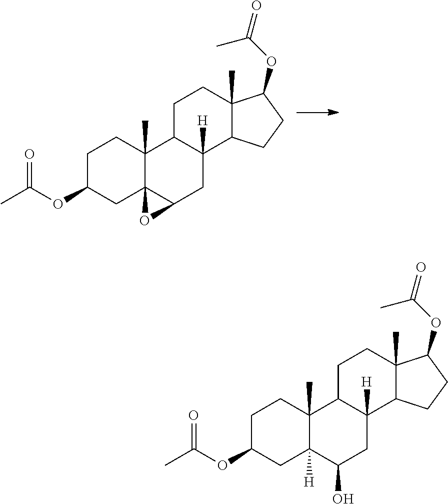

A solution of 5β-Androstane-3β,17β-diol, 5,6β-epoxy-, diacetate (Prepared as described in literature, see for example J. Chem. Research (Synopse), 2002, pp. 576) (0.941 g, 2.41 mmol), Sodium cyanoborohydride (0.53 g, 8.44 mmol), and a small quantity of bromocresol green indicator in 10 ml of dry THF was stirred, while Boron trifluoride-diethyl etherate (0.91 mL, 7.23 mmol) was added dropwise until a color change to yellow was noted, and stirring was continued under N2 atmosphere at reflux overnight. The mixture was diluted with a saturated solution of sodium chloride and extracted with ether (3×). The combined organic extracts were dried over sodium sulfate and the solvent was evaporated under vacuum. The residue was purified via Büchi Sepacore Cartridge 150×40, flow 50 ml/min, gradient of ethyl acetate in Cyclohexane 1 to 35% over 50 min giving 800 mg of 5.α.-Androstane-3.β.,6.β.,17.β.-triol, 3,17-diacetate (84.6% yield).). ¹H NMR (selected protons, CDCl₃, 400 MHz): 4.73 (m, 1H), 4.59 (t, 1H), 3.81 (sb, 1H), 2.03 (s, 6H, C(O)CH₃), 1.05 (s, 3H, CH₃), 0.82 (s, 3H, CH₃) ppm.

### Step 2: Synthesis of 3β,17β-Diacetoxy-5α-androstan-6-one

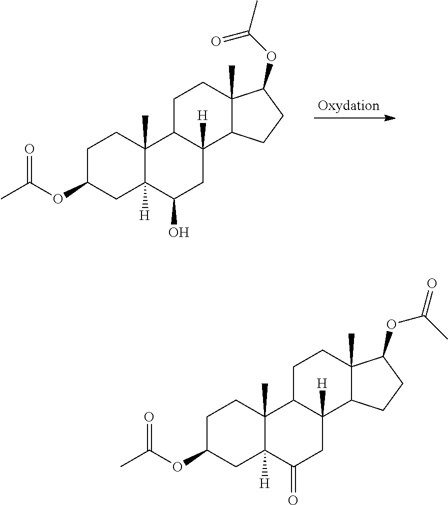

A solution of 5.α.-Androstane-3.β.,6.β.,17.β.-triol, 3,17-diacetate (1.87 g, 4.75 mmol) in dichloromethane (300 ml) was treated with pyridinium chlorochromate (2.08 mg, 9.50 mmol) and pyridinium trifluoroacetate (0.780 g, 4.04 mmol). The mixture was stirred for 2 h at room temperature and then filtered through Celite, and the solution evaporated under reduced pressure. The residue was purified via Büchi Sepacore (flow 50 ml/min, cartridge 40×75, gradient of AcOEt in CyHex 1 to 35% over 40 min) to give 3β,17β-Diacetoxy-5α-androstan-6-one (1.4 g, 76%).). ¹H NMR (selected protons, CDCl₃, 400 MHz): 4.63 (m, 2H), 2.05 (s, 3H, C(O)CH₃), 2.03 (s, 3H, C(O)CH₃), 0.78 (s, 3H, CH₃), 0.76 (s, 3H, CH₃) ppm.

### Step 3: Synthesis of 17β-acetoxy-3β-hydroxy-5α-androstan-6-one

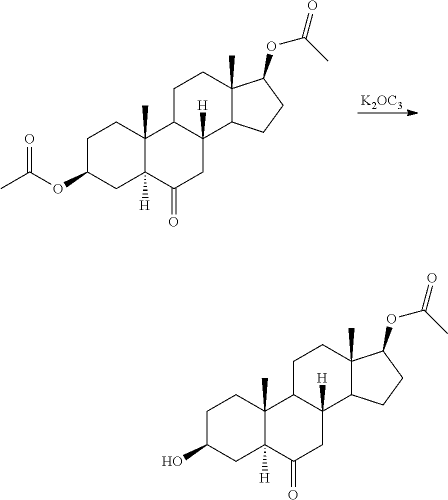

A solution of potassium carbonate (0.53 g, 3.87 mmol) in water (10 mL) and methanol (20 mL) was added to a solution of 3β,17β-Diacetoxy-5α-androstan-6-one (1.40 g, 3.58 mmol) in methanol (180 mL). After 2 h at room temperature, acetic acid (0.4 mL) was added and the solution was concentrated in vacuo, poured into brine and extracted with ethyl acetate (3×). The combined organic extracts were dried over sodium sulfate and the solvent evaporated. The residue was purified by column chromatography on silica gel (ethyl acetate/hexane) to give 17β-acetoxy-3β-hydroxy-5α-androstan-6-one (0.83 g, 67%). Mp° C.: 204° C. ¹H NMR (selected protons, CDCl₃, 400 MHz): 4.63 (t, 1H), 3.57 (m, 1H), 2.04 (s, 3H, C(O)CH₃), 0.78 (s, 3H, CH₃), 0.75 (s, 3H, CH₃) ppm.

### Step 4: Synthesis of 3α,17β-diacetoxy-5α-androstan-6-one

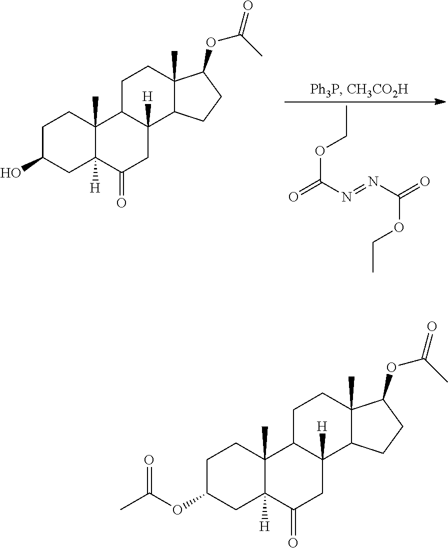

To a solution of 17β-acetoxy-3β-hydroxy-5α-androstan-6-one (0.819 g, 2.35 mmol) in anhydrous THF (20 mL) containing triphenylphosphine (1.23 g, 4.70 mmol) and acetic acid (0.27 mL, 4.70 mmol) was added a solution of diethylazodicarboxylate (0.819 g, 4.70 mmol) in anhydrous THF (5 mL). The reaction mixture was stirred at 70° C. overnight and evaporated to dryness after addition of silica gel. (15 mL). The residue was purified via Büchi Sepacore, cartridge 40×150, flow 50 ml/min, gradient of ethyl acetate in cyclohexane 1% to 40% over a 1h20 period.to give 3α,17β-Diacetoxy-5α-androstan-6-one (0.32 g, 35%). ¹H NMR (selected protons, CDCl₃, 400 MHz): 5.12 (sb, 1H), 4.62 (t, 1H), 2.05 (s, 3H, C(O)CH₃), 2.03 (s, 3H, C(O)CH₃), 0.81 (s, 3H, CH₃), 0.74 (s, 3H, CH₃) ppm.

### Step 5: Synthesis of 6α,6β-difluoro-3α,17β-di acetyloxy-5α-androstan

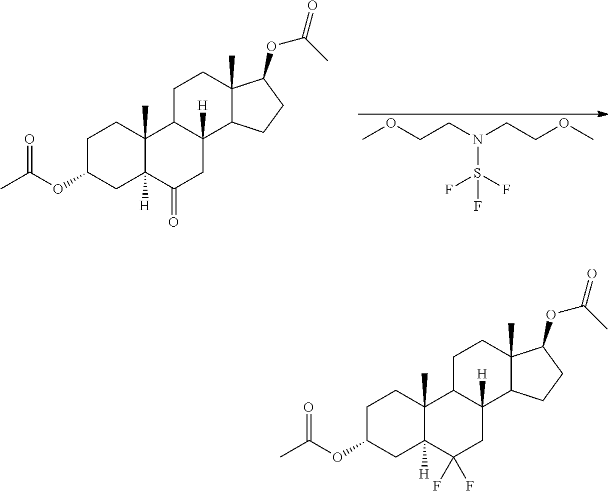

Deoxofluor (6.05 mL, 16.4 mmol, 50% solution) was added slowly over 5 min to a 0° C. solution of 3α,17β-Diacetoxy-5α-androstan-6-one (0.320 g, 0.82 mmol) in dichloromethane (5 mL). After 48 h at 80° C., the reaction was quenched by the careful addition of an equal volume of ice-water. After separation of the phases, the aqueous layer was extracted with dichloromethane (3×) and the combined organics were dried over sodium sulfate and concentrated under vacuum with 8 mL of SiOH 60. The purification was done by using a Büchi Sepacore (cartridge 40×75, flow 50 ml/min, gradient of ethyl acetate in cyclohexane 1 to 40% over 2 hours period, flow 50 ml/min) to give 6α,6β-difluoro-3α,17β-di acetyloxy-5α-androstan (0.290 g, 86% yield). ¹H NMR (selected protons, CDCl₃, 400 MHz): 5.15 (sb, 1H), 4.61 (t, 1H), 2.05 (s, 6H, 2×C(O)CH₃), 0.94 (d, 3H, CH₃), 0.81 (s, 3H, CH₃) ppm.

### Step 6: Synthesis of 6α,6β-difluoro-3α,17β-diol-5α-androstan

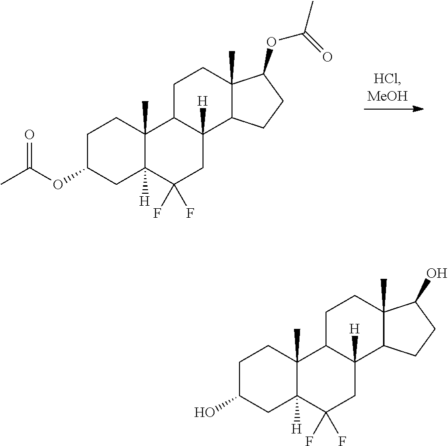

A solution of hydrochloric acid (2.0 mL) in methanol (10 mL) was added to a solution of 6α,6β-difluoro-3α,17β-di acetyloxy-5α-androstan (0.28 g, 0.68 mmol) in chloroform (2 mL) and the reaction mixture was allowed to stand at room temperature for 20 hours. A saturated solution of potassium carbonate was added and the product was extracted with dichloromethane (3×). The combined organic extracts were dried over sodium sulfate and the solvent evaporated. The purification was done by using a Büchi Sepacore (cartridge 12×150, flow 15 ml/min, gradient of AcOEt in CyHex 1% to 60% over 1.5 hrs) to give 6α,6β-difluoro-3α,17β-diol-5α-androstan (0.110 g, 49%). Mp° C.: 202-204° C.). ¹H NMR (selected protons, CDCl₃, 400 MHz): 4.20 (sb, 1H), 3.65 (t, 1H), 0.90 (d, 3H, CH₃), 0.75 (s, 3H, CH₃) ppm.

### Example P3

### Synthesis of 5-Fluoro-6α,6β-difluoro-3α,17β-dihydroxy-5α-androstan (compound 1.04)

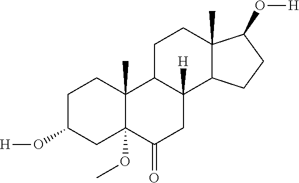

### Step 1: Synthesis of 5-methoxy-6β-hydroxy-3β,17β-di acetyloxy-5α-androstan

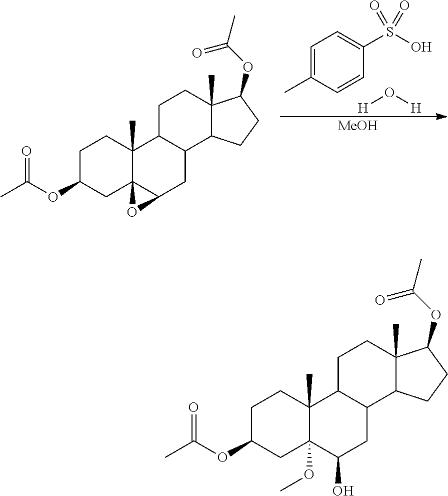

A solution of 5β-Androstane-3β,17β-diol, 5,6β-epoxy-, diacetate (Prepared as described in literature, see for example J. Chem. Research (Synopse), 2002, pp. 576) (0.5.55 g, 14.2 mmol), and p-toluenesulfonic acid monohydrate (0.27 g, 1.42 mmol) in methanol (1000 mL) was allowed to stand at room temperature overnight. The solution was poured into saturated aqueous solution of sodium hydrogenocarbonate (400 mL) and the methanol was evaporated under vacuum. The residue was extracted with Ether (3×), and the combined organic phases were washed with water, dried over sodium sulfate and concentrated under vacuum to give 5-methoxy-6β-hydroxy-3β,17β-di acetyloxy-5α-androstan (5.60 g, 93.3% yield). Mp° C.: 197-199° C. ¹H NMR (selected protons, CDCl₃, 400 MHz): 4.88 (m, 1H), 4.58 (t, 1H), 3.90 (sb, 1H), 3.22 (s, 3H, OCH₃), 2.04 (s, 6H, C(O)CH₃), 1.21 (s, 3H, CH₃), 0.79 (s, 3H, CH₃) ppm.

### Step 2: Synthesis of 5-methoxy-3β,17β-di acetyloxy-5α-androstan-6-one

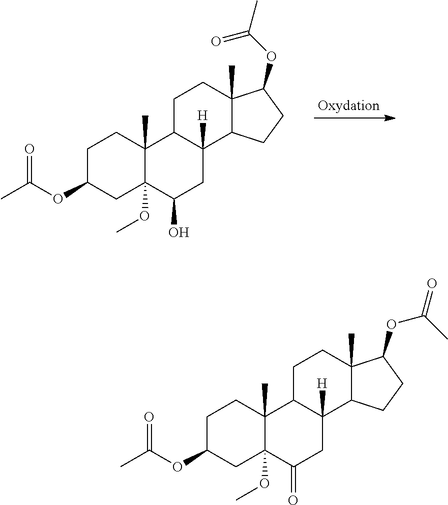

A solution of 5-methoxy-6β-hydroxy-3β,17β-di acetyloxy-5α-androstan (5.50 g, 13.02 mmol) in dichloromethane (1000 ml) was treated with pyridinium chlorochromate (5.69 g, 26.0 mmol) and pyridinium trifluoroacetate (2.14 g, 11.07 mmol). The mixture was stirred for 2 h at room temperature and then filtered through Celite, and the solution evaporated under reduced pressure. The residue was purified by flash chromatography ethyl acetatet/cyclohexane 1:4) to give 5-methoxy-3β,17β-di acetyloxy-5α-androstan-6-one (3.74 g, 68%). Mp° C.: 181-183° C.). ¹H NMR (selected protons, CDCl₃, 400 MHz): 4.82 (m, 1H), 4.63 (t, 1H), 3.17 (s, 3H, OCH₃), 2.04 (s, 6H, C(O)CH₃), 2.02 (s, 6H, C(O)CH₃), 0.82 (s, 3H, CH₃), 0.78 (s, 3H, CH₃) ppm.

### Step 3: Synthesis of 5-methoxy-3β-hydroxyl, 17β-acetyloxy-5α-androstan-6-one

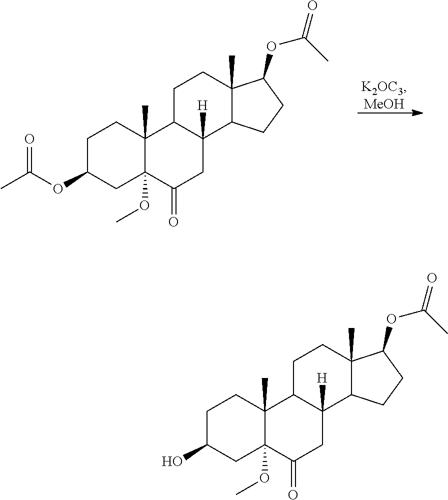

A solution of potassium carbonate (1.36 g, 9.83 mmol) in water (24 mL) and methanol (48 mL) was added to a solution of 5-methoxy-3β,17β-di acetyloxy-5α-androstan-6-one (3.83 g, 9.10 mmol) in methanol (350 mL). After 1 h at room temperature, acetic acid (1.3 mL) was added and the solution was concentrated in vacuum, poured into brine and extracted with ethyl acetate (3×). The combined organic extracts were dried over sodium sulfate and the solvent evaporated. The residue was purified by column chromatography on silica gel (ethyl acetate/hexane) to give 5-methoxy-3β-hydroxyl, 17β-acetyloxy-5α-androstan-6-one (1.90 g, 55%). Mp° C.: 183-185° C. ¹H NMR (selected protons, CDCl₃, 400 MHz): 4.62 (t, 1H), 3.75 (m, 1H), 3.09 (s, 3H, OCH₃), 2.04 (s, 6H, C(O)CH₃), 0.82 (s, 3H, CH₃), 0.77 (s, 3H, CH₃) ppm

### Step 4: Synthesis of 5-methoxy-3α,17β-diacetyloxy-5α-androstan-6-one

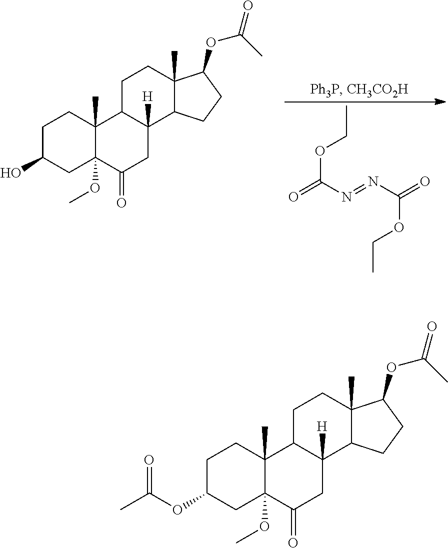

To a solution of 5-methoxy-3β-hydroxyl, 17β-acetyloxy-5α-androstan-6-one (1.75 g, 4.62 mmol) in anhydrous tetrahydrofurane (35 mL) containing triphenylphosphine (2.42 g, 9.24 mmol) and acetic acid (0.53 mL, 9.24 mmol) was added a solution of diethylazodicarboxylate (1.6 g, 9.24 mmol) in anhydrous THF (15 mL). The reaction mixture was stirred at 70° C. overnight and evaporated to dryness after addition of silica gel (15 mL). The residue was purified via Büchi Sepacore, cartridge 40×150, flow 50 ml/min, gradient of ethyl acetate in cyclohexane 1% to 40% over a 1h20 period.to give 5-methoxy-3α,17β-diacetyloxy-5α-androstan-6-one (0.58 g, 30%). ¹H NMR (selected protons, CDCl₃, 400 MHz): 5.11 (sb, 1H), 4.62 (t, 1H), 3.09 (s, 3H, OCH₃), 2.04 (s, 6H, C(O)CH₃), 2.03 (s, 6H, C(O)CH₃), 0.79 (s, 6H, CH₃) ppm.

### Step 5: Synthesis of 5-methoxy-3α,17β-dihydroxyl-5α-androstan-6-one

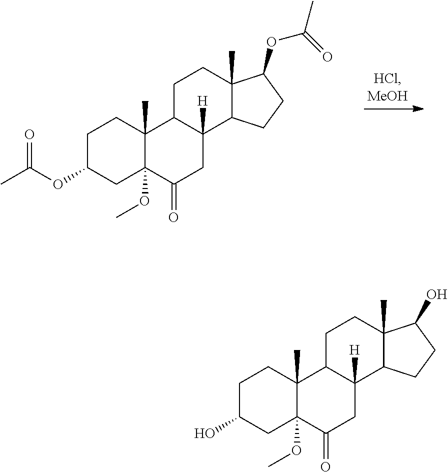

A solution of hydrochloric acid (2.0 mL) in methanol (20 mL) was added to a solution of 5-methoxy-3α,17β-diacetyloxy-5α-androstan-6-one (0.57 g, 1.35 mmol) in chloroform (4 mL) and the reaction mixture was allowed to stand at room temperature for 20 hours. A saturated solution of potassium carbonate was added and the product was extracted with dichloromethane (3×). The combined organic extracts were dried over sodium sulfate and the solvent evaporated. The purification was done by two successive crystallization (first with Ethanol/water, then with dichloromethane/cyclohexane)) to give 5-methoxy-3α,17β-dihydroxyl-5α-androstan-6-one (0.247 g, 54%). Mp° C.: 179-181° C. ¹H NMR (selected protons, CDCl₃, 400 MHz): 3.97 (m, 1H), 3.68 (m, 1H), 3.72 (s, 3H, OCH₃), 3.18 (d, 1H, OH), 0.78 (s, 6H, CH₃), 0.72 (s, 6H, CH₃) ppm.

### Biological Examples

The following examples illustrate the plant growth stimulation properties of compounds of formula (I). Tests were performed as follows:

### Example 1

Bean seeds of Phaseolus vulgaris L. cv. Pinto were germinated in drench soil in 140 ml pots; pots with 7-day old seedlings were thinned out to one seedling per pot. Young plants of 12-14 days with 2-3 mm long second internodes were used in bioassay screening experiments. Germination, early plant growth as well the screening of growth symptoms of young plants after application of compounds of formula (I) were done under similar glass house conditions: temperature 22° C. day/18° C. night, humidity 60%, day length 15 h day/9 h night. Plants were watered manually on a daily basis, as needed.

Compounds of formula (I) were applied through a wound site using a micropipette. The wound site was introduced through removal of one of the twin leaves of the first set of true leaves. Small amounts of compounds were delivered at a time. The wound site was sealed with 2-3 ml of Vaseline that was applied using a cotton ear bud. Compounds of formula (I) were dissolved in 99% ethanol and for the control/check a similar volume was used as for all treatments and in this case, the solution only contained 99% ethanol. Dilutions of stock solutions were made with distilled water. Eight replicates were included per treatment, including for the control. The scoring of growth elongation effects was performed after 10 days.

Growth promotion of bean plants by compounds of formula (I) was tested by scoring elongation of the second and third internode of bean plants. Scoring of growth stimulation effects was done by careful cutting and measuring the length of the two internodes. The results are described in Table 2. All compounds were tested at three rates (in mram per plant): 6, 20 and 200. Values represent the average percentage increase in stem elongation compared with the untreated control.

TABLE 2

| | | % increase compared with control, | | |
|---|---|---|---|---|
| | | by plant part | | |
| | Rate | | | Total elongation |
| Compound of | (μg per | | | (internode 2 + |
| formula I | plant) | Internode 2 | Internode 3 | internode 3) |
| Standard | 6 | 150 | 4 | 154 |
| P1 | 6 | 0 | 0 | 0 |
| P1 | 20 | 44 | 116 | 160 |
| P1 | 200 | 30 | 78 | 108 |
| P2 | 6 | 0 | 0 | 0 |
| P2 | 20 | 50 | 110 | 160 |
| P2 | 200 | 31 | 23 | 54 |
| P3 | 6 | 13 | 4 | 17 |
| P3 | 20 | 6 | 48 | 54 |
| P3 | 200 | 43 | 70 | 113 |

The standard compound (24-epi-brassinolide) at low concentrations elongated the second internode while almost no elongation of the third internode was evident. Elongation of internodes was evident for compounds P1 and P2 at the highest two rates, but not at the lowest rate. The elongation of internode 3 was higher for both compounds compared with the elongation response for internode 2. The medium rate resulted in the best plant growth promotion effect for compounds P1 and P2. Compound P3 resulted in elongation of both internodes at all three rates tested and a dose response in terms of total internode elongation was found with the highest rate resulting in the strongest elongation response. All three compounds (P1, P2 and P3) showed strong elongation of internode 3, suggesting better systemicity than the standard, 24-epi-brassinolide.

### Example 2

Field trials were carried out at 2 locations in South Africa on maize. Treatments as shown in tables 3 and 4 were applied by spray application at 5-6 leaf growth stage. Assessments were made of plant height, number of maize cobs per plot, and total maize yield at the end of the trial. The results in Table 3 and 4 are the mean of 6 replicates per treatment. The standard is an analog of the Formula I of the present invention, as described in WO2009/115060 (formula IV).

TABLE 3
Field trial at Kransfontein

| | | Plant height 9-10 | | Plant height 10 | | Number of cobs | | | |
|---|---|---|---|---|---|---|---|---|---|
| | Rate | leaf stage | | leaf stage | | per plot | | Yield | |
| | g | | % | | % | | % | | % |
| Treatments | AI/ha | cm | increase* | cm | increase* | Number | increase* | kg/ha | increase* |

| | | | | | | | | | |
|---|---|---|---|---|---|---|---|---|---|
| Control | n/a | 35.7 | n/a | 47.7 | n/a | 34.8 | n/a | 4132.1 | n/a |
| Standard | 0.3 | 36.3 | 1.7 | 48.7 | 2.1 | 33.3 | −4.3 | 4017.9 | −2.8 |
| Compound | 0.3 | 38.0 | 6.4 | 49.5 | 3.8 | 35.0 | 0.5 | 4203.2 | 1.7 |
| P3 | | | | | | | | | |
| Standard | 0.6 | 37.0 | 3.6 | 49.3 | 3.4 | 33.8 | −2.9 | 3985.2 | −3.6 |
| Compound | 0.6 | 36.8 | 3.1 | 49.7 | 4.2 | 37.5 | 7.7 | 4227.3 | 2.3 |
| P3 | | | | | | | | | |

*Represents percentage increase compared to untreated control

TABLE 4
Field trial at Lindley

| | | Plant height 6-7 | | Plant height 9 leaf | | Number of cobs | | | |
|---|---|---|---|---|---|---|---|---|---|
| | Rate | leaf stage | | stage | | per plot | | Yield | |
| | g | | % | | % | | % | | % |
| Treatments | AI/ha | cm | increase* | cm | increase* | Number | increase* | kg/ha | increase* |

| | | | | | | | | | |
|---|---|---|---|---|---|---|---|---|---|
| Control | n/a | 20.8 | n/a | 30.5 | n/a | 59.3 | n/a | 10761.7 | n/a |
| Standard | 0.3 | 21.5 | 3.4 | 31.0 | 1.6 | 60.0 | 1.1 | 10976.9 | 2.0 |
| Compound | 0.3 | 21.8 | 4.8 | 32.3 | 5.9 | 60.5 | 2.0 | 1115.9 | 3.3 |
| P3 | | | | | | | | | |
| Standard | 0.6 | 21.2 | 1.9 | 31.3 | 2.6 | 60.8 | 2.5 | 10890.5 | 1.2 |
| Compound | 0.6 | 21.5 | 3.4 | 33.2 | 8.9 | 62.0 | 4.5 | 11099.4 | 3.1 |
| P3 | | | | | | | | | |

*Represents percentage increase compared to untreated control

The results show that all treatments performed better than the untreated control. In particular, compounds of Formula I unexpectedly performed better than the standard in plant height, number of cobs, and yield at both trial locations.

1. A compound of formula (I) 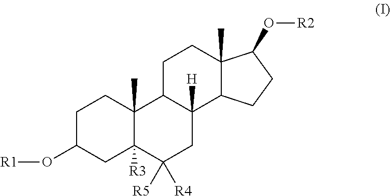
wherein
R1 and R2 are independently of one another H, C₁-C₈ alkyl, C₁-C₈ haloalkyl, C₁-C₈ alkylcarbonyl, or C₁-C₈ alkoxycarbonyl;
R3 is hydrogen, C₁-C₄ alkoxy or halogen; and
R4 and R5 either i) are independently of one another hydrogen, hydroxyl or halogen, or ii) form a carbonyl or thio-carbonyl group except when R3 is fluorine.

2. A compound according to claim 1, wherein R3 is hydrogen, C₁-C₄ alkoxy or fluore.

3. A compound according to claim 1, wherein R4 and R5 are independently of one another hydrogen or halogen.

4. A compound according to claim 1, wherein R4 and R5 form a carbonyl or thio-carbonyl group with the proviso that R3 is not fluorine.

5. A method of enhancing the growth of plants comprising applying to the plants, plant parts, plant propagation material, or a plant growing locus a compound of formula (I) 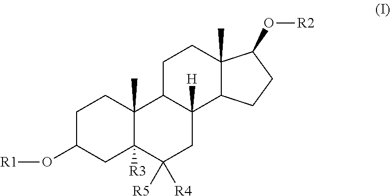
wherein
R1 and R2 are independently of one another H, C₁-C₄ alkyl, C₁-C₄ haloalkyl, C₁-C₄ alkylcarbonyl, or C₁-C₄ alkoxycarbonyl;
R3 is hydrogen, C₁-C₄ alkoxy or halogen; and
R4 and R5 either i) are independently of one another hydrogen, hydroxyl or halogen, or ii) form a carbonyl or thio-carbonyl group except when R3 is fluorine.

6. A method according to claim 5, wherein yield is increased.

7. A plant growth enhancing or regulating composition comprising a compound as defined in claim 1 and an agriculturally acceptable formulation adjuvant.

8. A method for enhancing or regulating the growth of plants in a locus, comprising applying to the plants, plant parts, plant propagation material or the locus an effective amount of a composition as defined in claim 7.

9. (canceled)

10. A method for improving the yield, vigour, quality, and/or tolerance to stress factors of plants comprising applying to the plants, plant parts, plant propagation material or a plant growing locus an effective amount of a compound as defined in claim 1, or a composition as defined in claim 7.
